(19) United States
(12) Patent Application Publication
(10) Pub. No.: US 2023/0315504 A1
(43) Pub. Date: Oct. 5, 2023

(54) NETWORK COMPONENT NAMING SYSTEM, METHOD, DEVICE, AND PROGRAM

(71) Applicant: RAKUTEN MOBILE, INC., Tokyo (JP)

(72) Inventors: Nitish KUMAR, Indore (IN); Pawan SHRIWAS, Indore (IN); Niyank BAM, Indore (IN); Pratik MAHAJAN, Indore (IN); Mohammodh IRFAN, Indore (IN); Mahesh HANWATKAR, Indore (IN)

(73) Assignee: RAKUTEN MOBILE, INC., Tokyo (JP)

(21) Appl. No.: 17/709,531

(22) Filed: Mar. 31, 2022

(51) Int. Cl. G06F 9/455

(52) U.S. Cl. CPC G06F 9/45558; G06F 2009/45595; G06F 2009/45562

(57) ABSTRACT

A method of automatically naming network components, the method being performed by at least one processor and comprising determining a first value associated with a naming rule, the first value indicating a type of naming rule; determining a first length associated with the naming rule, wherein the first length is based on the first value; determining at least one or more subparts associated with the naming rule, wherein each of the at least one or more subparts comprises a configuration and a subpart length, and wherein a combined subpart length of each of the at least one or more subparts is equal to the first length; and generating the naming rule for naming network components based on the first value, the first length, and the at least one or more subparts.

### BACKGROUND

In a network, unique and meaningful names to virtual objects and/or elements allow for accurate identification and management of the network and its devices. Manual name assignment of virtual objects in a network can be very tedious, time-consuming, and often erroneous. Because manual name assignment can be non-standard, there are increased chances of naming errors, naming redundancy and conflicts. Further, manual name assignment affords very little flexibility for changes.

### SUMMARY

According to embodiments, a method of naming network components, the method being performed by at least one processor, includes: determining a first value associated with a naming rule, the first value indicating a type of naming rule; determining a first length associated with the naming rule, wherein the first length is based on the first value; determining at least one or more subparts associated with the naming rule, wherein each of the at least one or more subparts comprises a configuration and a subpart length, and wherein a combined subpart length of each of the at least one or more subparts is equal to the first length; and generating the naming rule for naming network components based on the first value, the first length, and the at least one or more subparts.

According to embodiments, the method may include assigning an identifier to at least one virtual object using the naming rule.

According to embodiments, wherein the naming rule may be a first naming rule, and the method may include, generating a second naming rule based on a second value, a second length, and one or more second subparts; and assigning an identifier to at least one virtual object using a combination of the first naming rule and the second naming rule.

According to embodiments, the determining of the at least one or more subparts associated with the naming rule may include identifying a reference entity from a predefined list of one or more reference entities based on determining that the configuration matches a pre-defined configuration.

According to embodiments, the predefined list of one or more reference values may be extracted from one of an internal or external database.

According to embodiments, the determining of the at least one or more subparts associated with the naming rule may include identifying at least one key-value pair based on determining that the configuration matches a pre-defined configuration.

According to embodiments, the method may include assigning an identifier indicating a dependency to at least one virtual object using the naming rule based on determining that a first subpart of the one or more subparts may depend on a second subpart of the one or more subparts.

According to embodiments, the method may include the first value and the first length being obtained from a user through one of a user interface or an application programming interface.

According to embodiments, the method may include revocation of the assigned identifier based on receiving user input indicating revocation.

According to embodiments, a device for naming network components, the device comprising: a memory configured to store instructions; and one or more processors configured to execute the instructions to: determine a first value associated with a naming rule, the first value indicating a type of naming rule; determine a first length associated with the naming rule, wherein the first length is based on the first value; determine at least one or more subparts associated with the naming rule, wherein each of the at least one or more subparts comprises a configuration and a subpart length, and wherein a combined subpart length of each of the at least one or more subparts is equal to the first length; and generate the naming rule for naming network components based on the first value, the first length, and the at least one or more subparts.

According to embodiments, a non-transitory computer-readable medium stores instructions including: one or more instructions that, when executed by one or more processors of a device for automatic troubleshooting, cause the one or more processors to: determine a first value associated with a naming rule, the first value indicating a type of naming rule; determine a first length associated with the naming rule, wherein the first length is based on the first value; determine at least one or more subparts associated with the naming rule, wherein each of the at least one or more subparts comprises a configuration and a subpart length, and wherein a combined subpart length of each of the at least one or more subparts is equal to the first length; and generate the naming rule for naming network components based on the first value, the first length, and the at least one or more subparts.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 is a diagram of a network component naming and management system, according to embodiments;

FIG. 2 is a flowchart of example processes for network component naming and management, according to embodiments;

FIG. 3 is a flowchart of an example process for network component naming and management, according to embodiments;

FIG. 4 is a flowchart of an example process for network component naming and management, according to embodiments;

FIG. 5 is a flowchart of an example process for network component naming and management, according to embodiments;

FIG. 6 is a flowchart of an example process for network component naming and management, according to embodiments;

FIG. 7 is an example illustration of a user interface for generating a name using a naming rule, according to embodiments;

embodiments;

FIG. 8A is a diagrammatic representation of a naming rule, according to FIG. 8B is an example illustration of a name generated using a naming rule, according to embodiments;

FIG. 8C is an example illustration of a user interface for generating a name using a naming rule, according to embodiments;

FIGS. 9A-B are example illustrations of a user interface for generating a naming rule, according to embodiments;

FIGS. 10A-B are example illustrations of a user interface for generating a naming rule, according to embodiments;

FIG. 11 is a diagram of an example environment in which systems and/or methods, described herein, may be implemented, according to embodiments; and

FIG. 12 is a diagram of example components of one or more devices of FIG. 11, according to embodiments.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

As is traditional in the field, embodiments may be described and illustrated in terms of blocks which carry out a described function or functions. These blocks, which may be referred to herein as units or modules or the like, may be physically implemented by analog or digital circuits such as logic gates, integrated circuits, microprocessors, microcontrollers, memory circuits, passive electronic components, active electronic components, optical components, hardwired circuits, or the like, and may be driven by firmware and software. The circuits may, for example, be embodied in one or more semiconductor chips, or on substrate supports such as printed circuit boards and the like. Circuits included in a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise.

As stated above, manual name assignment of virtual objects in a network can be very tedious, time-consuming, and often an erroneous process. Because manual name assignment can be non-standard, there are increased chances of naming errors, naming redundancy and conflicts. Further, manual name assignment affords very little flexibility for changes. The lack of flexibility may not allow for names to be meaningful across an organization or even within different parts of an organization. These disadvantages result in decreased efficiency of the network, increased errors in managing the virtual objects of the network, and a decreased speed of allocation and de-allocation of names and resources across the network.

Embodiments may relate to adaptive and/or automatic naming of virtual objects in a system, where an automatic standard naming pattern may be defined, and then used to name a plurality of virtual objects. By standardizing the naming pattern via a naming rule, a naming rule as a template may be created to name a plurality of virtual objects at the same time. Standardizing the naming pattern via a naming rule decreases the risk of erroneous naming or creating conflicts, and can improve the performance of the network. Embodiments of the present disclosure, performed for example by one or more processors of an element attached to or associated with a network, may be used to create naming rules with customizable subparts, lengths, datatypes, delimiters, among others. The ability to customize a naming rule makes names of virtual objects significant and meaningful throughout an organization, thereby improving functionalities across an organization and assisting in managing virtual objects in a network. As an example, host and server naming conventions can be customized and standardized within an organization or across an organization. Further, embodiments of the present disclosure may be used to create multiple naming rules specific to the location of the virtual objects, subpart configurations, data types, etc. Using embodiments described herein, naming virtual objects may be automated and hence much faster and more accurate.

Further, embodiments of the present disclosure may allow human involvement to be reduced by providing an automated capability where a template may be automatically used to create a meaningful name for a virtual object in a network. By doing so, operating costs in the telecommunication industry may be reduced and auto-creating and/or auto-naming functionality may be provided. Thus, embodiments of the present disclosure can increase the efficiency of the network, decrease errors in managing the virtual objects of the network, and increase the speed of allocation and de-allocation of names and resources across the network.

Embodiments of the present disclosure allow for a naming rule with customizable length of complete name, individual subpart configuration, datatype, length, and delimiter to be used as a template to generate unique and meaningful names within a network enabling faster name generation with flexibility of allocation and de-allocation.

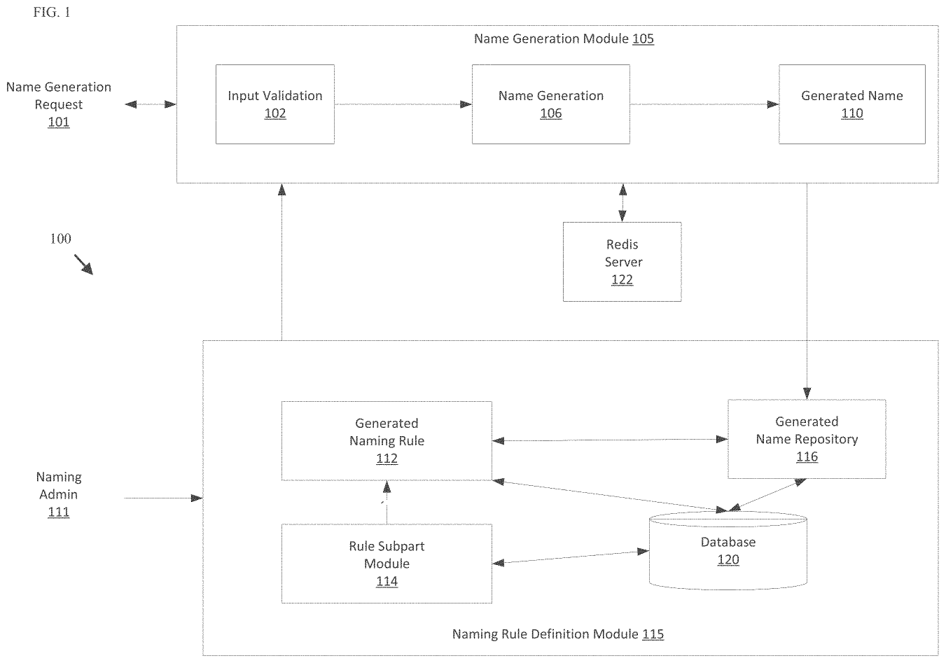

FIG. 1 is a diagram of an overview of an embodiment described herein. As shown in FIG. 1, a network component naming and management system 100 may be used to define one or more naming rules and/or may also be used to generate a plurality of names or identifiers for one or more virtual objects and/or network devices in a network using the defined and/or stored naming rules.

Referring to FIG. 1, name generation request 101 may request name generation through a name generation module 105. In some embodiments, name generation request 101 may be instantiated by an end user requesting a unique name generation. In some embodiments, name generation request 101 may be instantiated by an end user requesting unique name generation using a user interface. In some embodiments, name generation request 101 may be instantiated by an end user requesting unique name generation using an application programming interface. In some embodiments, name generation request 101 may be instantiated by a processor or network device automatically, requesting unique name generation for one or more virtual objects and/or network devices in a network. As an example, in some embodiments, name generation request 101 may be instantiated by a processor or network device automatically, requesting unique name generation for one or more virtual objects and/or network devices in a network based on detecting one or more unnamed devices and/or unnamed virtual objects in the network. As an example, the name generation request may be automatically instantiated by a processor or network device requesting unique hostnames or server names based on identifying one or more unnamed devices and/or unnamed virtual objects in the network.

In some embodiments, name generation request 101 may include input data associated with the network device and/or virtual device to be named. As an example, name generation request 101 may include input data indicating the naming rule to be used, a length of the name, individual subparts, data types associated with the naming rule and/or individual subparts, and pointers to additional data as needed to generate a unique and meaningful name for a network device and/or virtual device. In some embodiments, pointers to additional data may include information to access and extract data from internal or external databases.

As shown in FIG. 1, name generation module 105 may generate a name based on one or more naming rules upon receiving a name generation request 101. In some embodiments, name generation module 105 may transmit the generated name 110 to the requestor. As an example, name generation module 105 may transmit the generated name 110 to an end user via a user interface or an application programming interface. As another example, name generation module 105 may transmit the generated name 110 to one or more processors or network devices that may have requested a name generation.

In some embodiments, input validation 102 may validate the input data provided with the name generation request 101. In some embodiments, name generation request 101 may include an identifying attribute associated with a naming rule. As an example, in some embodiments, name generation request 101 may include the title and/or ID number of a naming rule. In some embodiments, the name generation module 105 and/or input validation 102 may read the naming rule associated with the identifying attribute from the naming rule definition module 115 and/or from a database 120. Based on reading the naming rule associated with the identifying attribute, input validation 102 may validate input data to determine whether a name may be generated using the input data. As an example, input validation 102 may validate whether the length of the identifying attribute (e.g., length of the title/name of the naming rule) matches the length in the identified naming rule, whether the individual subparts and data types associated with the individual subparts from the input data match that in the identified naming rule. In some embodiments, name generation 106 may generate a unique and meaningful name generated name 110 based on the input data and the identified naming rule read from the naming rule definition module 115. The unique and meaningful generated name 110 may be stored and/or written in a generated name repository 116. In some embodiments, the generated name repository 116 may be implemented on internal or external storage. In some embodiments, the name generation module 105 or the naming rule definition module 115 may use a redis server 122 for storing and/or retrieving data and data structures.

In some embodiments, the name generation module 105 may be implemented using one or more processors and/or network devices. In some embodiments, the name generation module 105 may be implemented via an application programming interface.

As shown in FIG. 1, naming admin 111 may define and/or generate one or more naming rules. In some embodiments, the naming admin 111 may be an end user or an individual with specific privileges for creating naming rules. In some embodiments, one or more processors and/or network devices may be the naming admin 111. As an example, a processor or authorized network device may be the naming admin 111. In some embodiments, the naming admin 111 may be triggered automatically and/or remotely using another processor and/or network device.

In some embodiments, a naming admin 111 may define a unique identifying attribute associated with a naming rule. As an example, naming admin 111 may define a naming rule using a unique title enabling easy identification of the generated naming rule 112. Associating a unique identifying attribute with a naming rule enables easier identification of the naming rule and improves network management.

In some embodiments, the naming admin 111 may also define a first value associated with a naming rule. In some embodiments, the first value associated with the naming rule may indicate the type of naming rule. As an example, the first value may indicate that the naming rule may be one of fixed length, variable length, a Media Access Control (MAC) address, or a E-UTRAN Cell Global Identifier (ECGI). Based on the first value, a first length associated with the naming rule may be determined and/or defined.

In some embodiments, based on determining that the type of naming rule may be fixed length, the first length may be defined and/or determined to be of a pre-determined size between 1-32 characters. In some embodiments, based on determining that the type of naming rule may be variable length, the first length may be defined and/or determined to be a user defined and/or customizable value. Any user interface or user input method may be used to determine the first length. In some embodiments, based on determining that the type of naming rule may be ECGI, the first length may be defined and/or determined to be equal to the length of a unique combination of a Mobile Country Code (MCC), Mobile network Code (MNC), and/or an E-UTRAN cell identifier (ECI). In some embodiments, based on determining that the type of naming rule may be MAC address, the first length may be defined and/or determined to be equal to the length of a unique identifier assigned to a network interface controller (NIC) for use as a network address for communications within a network.

In some embodiments, a naming rule may be associated with one or more subparts. As an example, a naming rule may be associated with up to seven subparts. As another example, the maximum number of subparts that may be included in a naming rule may be customized based on the first value.

In some embodiments, the one or more subparts associated the naming rule may include at least a subpart configuration and a subpart length. Information associated with subparts of a naming rule may be stored from the rule subpart module 114. Further, in some embodiments, information associated with subparts of a naming rule may be retrieved from the rule subpart module 114. As an example, in some embodiments, input validation 102 may retrieve rule subparts from the rule subpart module 114 for input validation.

Based on determining that a subpart configuration matches a pre-determined configuration, a reference entity from a predefined list of one or more reference entities may be identified. As an example, based on determining that a subpart configuration matches an entity configuration, a reference entity may be identified and/or determined to be one of a city, a prefecture, a location, a network cluster, a network section, a network sector, or a network characteristic. In some embodiments, the naming admin 111 may define and/or determine the reference entities on the predefined list. In some embodiments, the reference entities on the predefined list may be extracted from an internal or external database. As an example, the reference entities on the predefined list may be extracted from databases associated with different sections and/or functionalities of an organization. In some embodiments, based on determining that reference entities on the predefined list may be extracted from an internal or external database, a table, column, or identifier associated with the internal or external database may be provided to extract the possible values of the reference entity. As an example, based on determining that the subpart configuration matches an entity configuration; and the reference entity may be determined to be a city; a table, column, or identifier associated with the internal or external database may be provided to extract the cities that may be used in the subpart definition and the naming rule. As another example, based on determining that the subpart configuration matches an entity configuration, and the reference entity may be determined to be a network cluster, a table, column, or identifier associated with the internal or external database may be provided to extract the network clusters that may be used in the subpart definition and the naming rule.

In some embodiments, based on determining that a subpart configuration matches a pre-determined configuration, at least one key-value pair may be identified and used in generating names for one or more virtual objects and/or network devices in a network. As an example, based on determining that a subpart configuration matches a list of values configuration, one or more key-value pairs may be identified and/or determined for generating names for one or more virtual objects and/or network devices in a network. In some embodiments, naming admin 111 may define and/or determine the key-value pairs that may be used for a naming rule when creating the naming rule. In some embodiments, key-value pairs may be user defined or customized based on the rule type, subpart configuration, location, or even functionality of the naming rule. In some embodiments, the key-value pairs may be purely alphabets, alpha-numeric, or numeric. In some embodiments, the keys associated with the subpart may be customized based on the rule type, subpart configuration, location, or even functionality of the naming rule and the value may be user defined or defined and/or determined by the naming admin 111. In some embodiments, the keys associated with the subpart may be extracted from an internal or external database.

In some embodiments, based on determining that a subpart configuration matches a pre-determined configuration, a constant value may be identified and used in generating names for one or more virtual objects and/or network devices in a network. As an example, in an embodiment, based on determining that a subpart configuration matches a constant configuration, a constant value of the subpart length may be identified and used in generating names for one or more virtual objects and/or network devices in a network. In some embodiments, naming admin 111 may define and/or determine the constant value that may be used for a naming rule when creating the naming rule. In some embodiments, the constant value may be customized based on the type of virtual object and/or network device, function of the virtual object and/or network device, and part of the organization the virtual object and/or network device may be associated with. As an example, the constant value may be “uhn” (universal host name).

In some embodiments, based on determining that a subpart configuration matches a pre-determined configuration, at least one range of values may be determined and used in generating names for one or more virtual objects or network devices in a network. As an example, based on determining that a subpart configuration matches range configuration, one or more minimum values or maximum values may be identified and/or determined for generating names for one or more virtual objects or network devices in a network. In some embodiments, the minimum value or maximum value associated with the subpart may be automatically determined based on subpart length. As an example, based on determining that the subpart length may be 8, the minimum value may be automatically determined to be 1 and/or the maximum value may be automatically determined to be 99999999.

In some embodiments, based on determining that a subpart configuration matches a pre-determined configuration, at least one counter may be determined and used in generating names for one or more virtual objects or network devices in a network. As an example, based on determining that a subpart configuration matches range configuration, one or more counter values may be identified and/or determined for generating names for one or more virtual objects or network devices in a network. In some embodiments the counter value may be used to calculate the number of skips to generate the next number in the range. In some embodiments, the counter value may be used to calculate the next number in the range based on the minimum value and the maximum value associated with the subpart.

In some embodiments, a first subpart of the one or more subparts may depend on a second subpart of the one or more subparts. As an example, a reference entity of city in a second subpart may be used to determine a next value of the range in another subpart. As another example, the counter value may depend on information, attribute, or value associated one of the other subparts associated with the naming rule. In some embodiments, based on determining that the first subpart of the one or more subparts may depend on the second subpart of the one or more subparts associated with the naming rule, assigning an identifier to at least one virtual object and/or network device using the naming rule, wherein the assigned identifier indicates the dependency.

In some embodiments, a combined subpart length of each of the at least one or more subparts associated with a naming rule may be equal to the first length associated with the naming rule. As an example, if the naming rule length is 16, the combined subpart length of each of the naming rule's subparts may be equal to 16. In some embodiments, a naming rule may be added to generated naming rule 112 based on determining that the naming rule may be valid and the combined subpart length of each of the naming rule's subparts being equal to the first length associated with the naming rule.

In some embodiments, based on determining that the naming rule has more than two subparts, the naming admin 111 may define and/or determine a suffix delimiter to differentiate between the subparts of the naming rule. As an example, a period, a hyphen, a forward slash, a semicolon, a colon, or an underscore may be used as delimiters.

In some embodiments, the naming rule may be generated based on the first value, the first length, and the at least one or more subparts. The generated naming rule 112 may be stored in a database 120 and/or on a storage medium. Database 120 may be an internal or external database.

In some embodiments, the naming rule may be generated based on a combination of a first and second naming rule. In some embodiments, a first naming rule may be generated based on the first value, the first length, and the at least one or more subparts; a second naming rule may be generated based on a second value, a second length, and one or more second subparts; and a new naming rule may be generated based on a combination of the first naming rule and the second naming rule. Then, a virtual object and/or network device may be assigned an identifier based on the new naming rule generated based on the combination of the first naming rule and the second naming rule. In some embodiments, the first naming rule and second naming rule may have already been generated and stored as generated naming rule 112 in a database 120. The naming admin 111 may combine the already stored first naming rule and the second naming rule automatically to generate the new naming rule. Generation of a combined naming rule using already stored naming rules will increase efficiency, reduce errors, and streamline management of the network as well as the virtual objects and/or devices in the network.

Once a naming rule may be generated and or defined, one or more virtual objects and/or network devices may be assigned a unique identifier generated using the naming rule. In some embodiments, the unique identifier may be generated automatically based on a name generation request 101 for one or more virtual objects and/or network devices.

In some embodiments, based on receiving input indicating revocation, an assigned identifier to one or more virtual objects and/or network devices may be revoked. As an example, name generation request 101 may request revocation of a name assigned to one or more virtual objects and/or network devices. In some embodiments, the revocation be instantiated by an end user using a user interface. In some embodiments, the revocation be instantiated by an end user using an application programming interface. In some embodiments, the revocation may be instantiated by a processor or network device automatically one or more virtual objects and/or network devices in a network. As an example, in some embodiments, the revocation may be instantiated by a processor or network device automatically for one or more virtual objects in a network based on detecting unauthorized actions or actions harmful to the network from one or more network devices and/or virtual objects in the network.

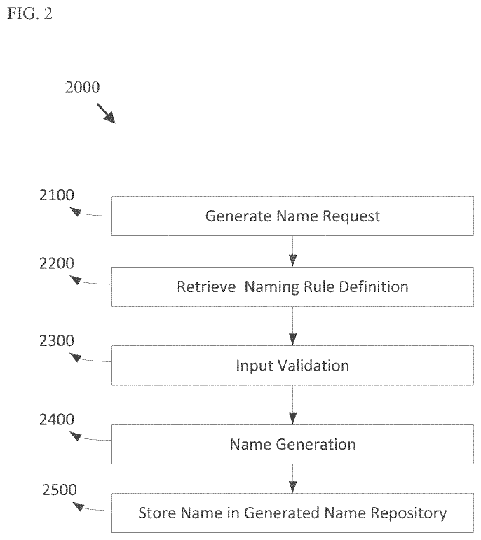

FIG. 2 is a flowchart illustrating an example process 2000 for generating a name based on a naming rule which may be implemented by systems and devices as described herein.

At 2100, a name generation request may be generated. As an example, name generation request 101 may request name generation through a name generation module 105. In some embodiments, name generation request 101 may be instantiated by an end user. In some embodiments, a processor or network device may automatically request name generation for one or more virtual objects and/or network devices in a network.

At 2200, naming rule definition is retrieved from a database based on an identifying attribute of the naming rule definition. As an example, in some embodiments, name generation request 101 may include the title and/or ID number of a naming rule and the name generation module 105 and/or input validation 102 may read the naming rule associated with the identifying attribute from the naming rule definition module 115 and/or from a database 120.

At 2300, input data validation may be performed. In some embodiments, name generation request 101 may include input data associated with the network device and/or virtual device to be named. Input validation 102 may validate the input data provided with the name generation request 101. As an example, input validation 102 may validate whether the length of the identifying attribute (e.g., length of the title/name of the naming rule) matches the length in the identified naming rule, whether the individual subparts and data types associated with the individual subparts from the input data match that in the identified naming rule.

At 2400, a unique and meaningful name may be generated based on the input data and the identified naming rule. At 2500, the unique and meaningful generated name may be stored and/or written in a generated name repository 116.

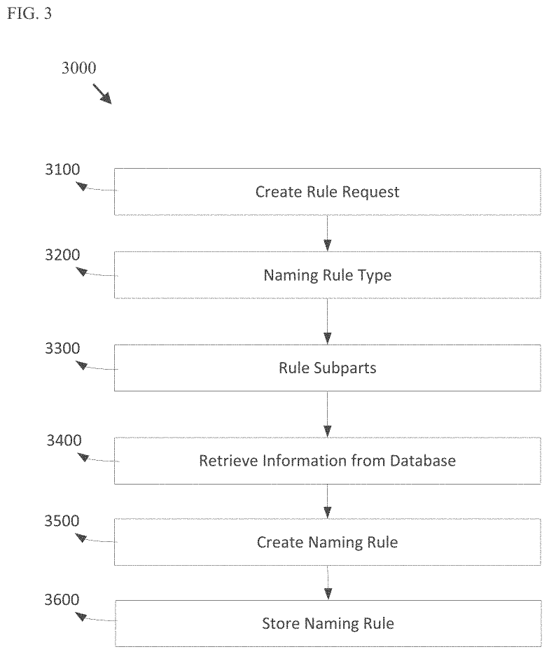

FIG. 3 is a flowchart illustrating an example process 3000 for creating a naming rule and/or template which may be implemented by systems and devices as described herein.

At 3100, a request to create a naming rule may be generated. As an example, naming admin 111 may request define and/or generate one or more naming rules.

At 3200, a naming rule type may be determined. In some embodiments, the naming admin 111 may define a first value associated with a naming rule, the first value indicating the type of naming rule. As an example, the first value may indicate that the naming rule may be one of fixed length, variable length, a Media Access Control (MAC) address, or a E-UTRAN Cell Global Identifier (ECGI). In some embodiments, determining the naming type may include determining a first length associated with the naming rule. In some embodiments, the first length may be based on the type of naming rule.

At 3300, one or more rule subparts may be defined. A naming rule may be associated with one or more individual subparts. In some embodiments the one or more subparts may be independent of each other. In some embodiments the one or more subparts may be dependent of each other. In some embodiments, the one or more subparts associated the naming rule may include at least a subpart configuration and a subpart length.

At 3400, information associated with the one or more subparts may be retrieved from a database. As an example, information associated with subparts of a naming rule may be retrieved from the rule subpart module 114. As another example, information relating to reference entities on predefined lists, key-value pairs, and ranges may be retrieved from an internal or external database.

At 3500, the naming rule may be generated. In some embodiments, the naming rule may be generated based on the first value, the first length, and the at least one or more subparts. In some embodiments, the naming rule may be generated based on a combination of a first and second naming rule.

At 3600, the generated naming rule may be stored in a database or a repository. As an example, generated naming rule 112 may be stored in a database 120 and/or on a storage medium.

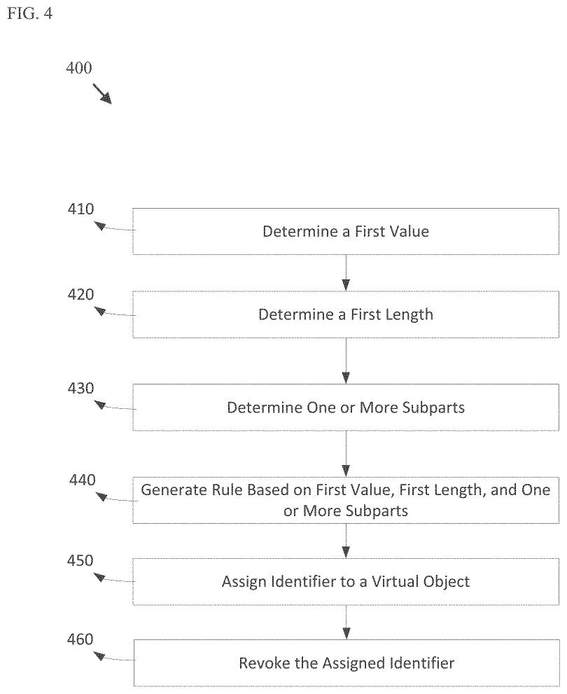

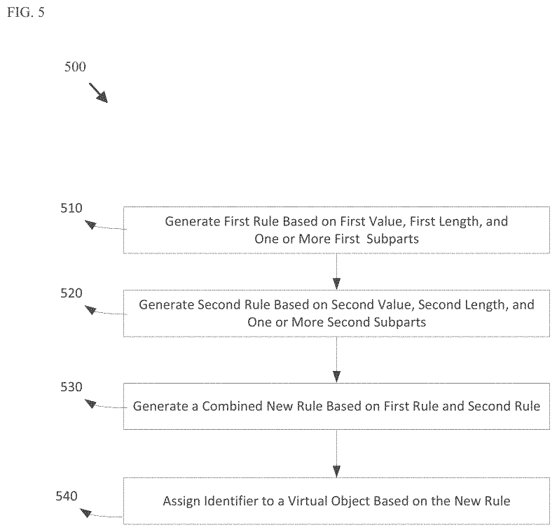

FIG. 4 is a flowchart illustrating an example process 400 for creating and assigning a name for virtual 400 which may be implemented by systems and devices as described herein.

At 410, a first value associated with a naming rule may be determined. In some embodiments, the first value associated with the naming rule may indicate the type of naming rule. As an example, in some embodiments, the naming admin 111 may define a first value associated with a naming rule.

At 420, a first length associated with the naming rule may be determined. In some embodiments, the first length may be based on the first value. As an example, in some embodiments, based on determining that the type of naming rule may be fixed length, the first length may be defined and/or determined to be of a pre-determined size between 1-32 characters. As another example, in some embodiments, based on determining that the type of naming rule may be variable length, the first length may be defined and/or determined to be a user defined and/or customizable value. As another example, in some embodiments, based on determining that the type of naming rule may be MAC address, the first length may be defined and/or determined to be equal to the length of a unique identifier assigned to a network interface controller (NIC) for use as a network address for communications within a network. As another example, in some embodiments, based on determining that the type of naming rule may be ECGI, the first length may be defined and/or determined to be equal to the length of a unique combination of a Mobile Country Code (MCC), Mobile network Code (MNC), and/or an E-UTRAN cell identifier (ECI).

At 430, one or more subparts associated with the naming rule may be determined. As an example, a naming rule may be associated with up to seven subparts. As another example, the maximum number of subparts that may be included in a naming rule may be customized based on the first value. In some embodiments, each of the one or more subparts associated the naming rule may include at least a subpart configuration and a subpart length.

At 440, the naming rule may be generated. In some embodiments, the naming rule may be generated based on the first value, the first length, and the at least one or more subparts. In some embodiments, the naming rule may be generated based on a combination of a first and second naming rule.

At 450, a virtual object and/or network device may be assigned an identifier based on the generated naming rule. In some embodiments, the unique identifier may be generated automatically based on a name generation request 101 for one or more virtual objects and/or network devices.

At 460, an assigned identifier to one or more virtual objects and/or network devices may be revoked based on receiving input indicating revocation. As an example, name generation request 101 may request revocation of a name assigned to one or more virtual objects and/or network devices. In some embodiments, the revocation be instantiated by an end user using a user interface. In some embodiments, the revocation may be instantiated by a processor or network device automatically for one or more virtual objects in a network based on detecting unauthorized actions or actions harmful to the network from one or more network devices and/or virtual objects in the network.

FIG. 5 is a flowchart illustrating an example process 500 which may be implemented by systems and devices as described herein.

At 510, a first naming rule may be generated based on the first value, the first length, and the at least one or more subparts. In some embodiments, the first naming may have already been generated and stored as generated naming rule 112 in a database 120. At 520, a second naming rule may be generated based on a second value, a second length, and one or more second subparts. In some embodiments, the second naming rule may have already been generated and stored as generated naming rule 112 in a database 120. At 530, a new naming rule may be generated based on a combination of the first naming rule and the second naming rule. As an example, naming admin 111 may automatically combine the already stored first naming rule and the second naming rule automatically to generate the new naming rule. At 540, a virtual object and/or network device may be assigned an identifier based on the new naming rule generated based on the combination of the first naming rule and the second naming rule.

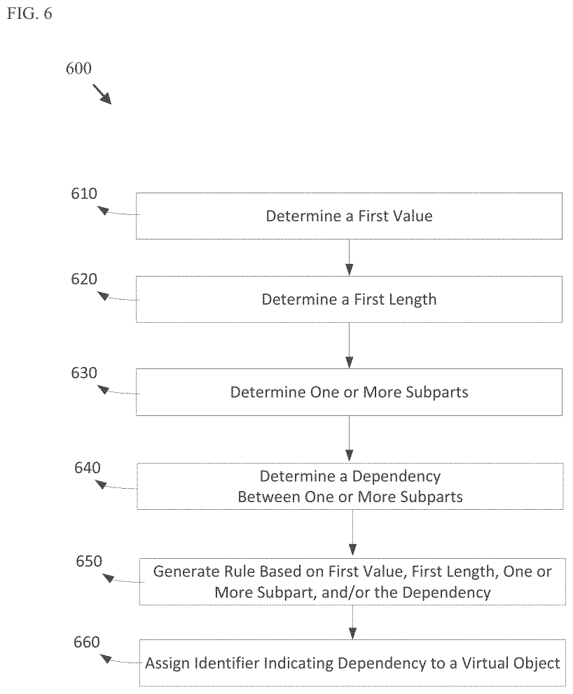

FIG. 6 is a flowchart illustrating an example process 600 which may be implemented by systems and devices as described herein.

At 610, a first value associated with a naming rule may be determined. In some embodiments, the first value associated with the naming rule may indicate the type of naming rule. As an example, in some embodiments, the naming admin 111 may define a first value associated with a naming rule.

At 620, a first length associated with the naming rule may be determined. In some embodiments, the first length may be based on the first value. As an example, in some embodiments, based on determining that the type of naming rule may be fixed length, the first length may be defined and/or determined to be of a pre-determined size between 1-32 characters. As another example, in some embodiments, based on determining that the type of naming rule may be variable length, the first length may be defined and/or determined to be a user defined and/or customizable value. As another example, in some embodiments, based on determining that the type of naming rule may be MAC address, the first length may be defined and/or determined to be equal to the length of a unique identifier assigned to a network interface controller (NIC) for use as a network address for communications within a network. As another example, in some embodiments, based on determining that the type of naming rule may be ECGI, the first length may be defined and/or determined to be equal to the length of a unique combination of a Mobile Country Code (MCC), Mobile network Code (MNC), and/or an E-UTRAN cell identifier (ECI).

At 630, one or more subparts associated with the naming rule may be determined. As an example, a naming rule may be associated with up to seven subparts. As another example, the maximum number of subparts that may be included in a naming rule may be customized based on the first value. In some embodiments, each of the one or more subparts associated the naming rule may include at least a subpart configuration and a subpart length.

At 640, a dependency between one or more subparts may be determined. As an example, in some embodiments, a first subpart of the one or more subparts may depend on a second subpart of the one or more subparts.

At 650, a naming rule indicating the dependency may be generated based on determining that the first subpart of the one or more subparts may depend on the second subpart of the one or more subparts associated with the naming rule.

At 660, an identifier to at least one virtual object and/or network device using the naming rule based on determining that the first subpart of the one or more subparts may depend on the second subpart of the one or more subparts associated with the naming rule, wherein the assigned identifier indicates the dependency. In some embodiments, the naming admin 111 may request skipping operation 650 and directly proceeding to operation 660.

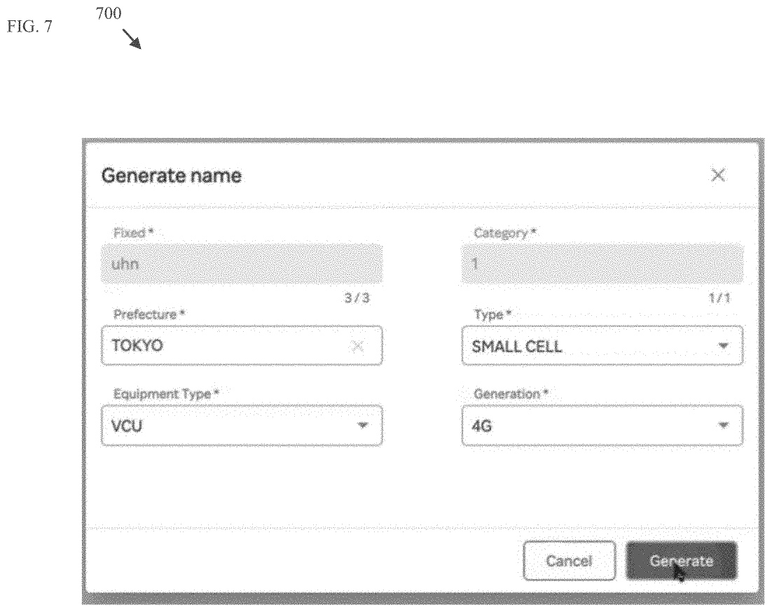

FIG. 7 illustrates a diagram of a user interface 700 displaying a result of the network component naming and management process 100, according to embodiments.

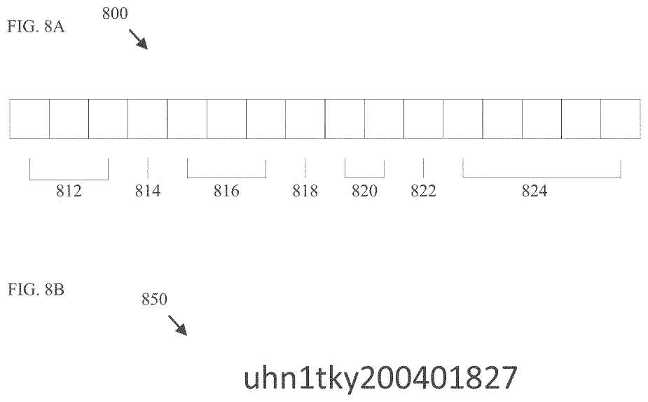

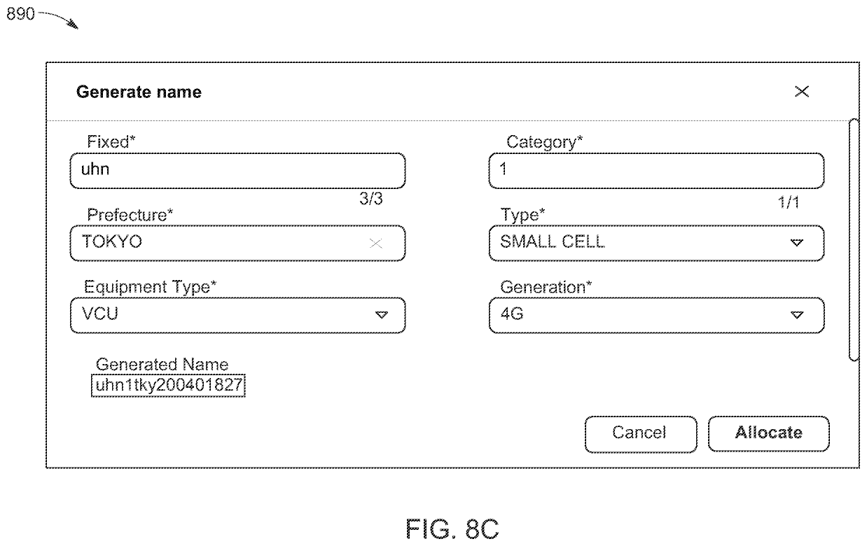

FIGS. 8A-C illustrate an example name generated using a naming rule.

FIG. 8A illustrates a diagram of a shell 800 of an exemplary name generated using a naming rule generated as a result of the network component naming and management process 100, according to embodiments. As shown in FIG. 8A, the naming rule shell may include seven subparts 812, 814, 816, 818, 820, 822, and 824. Each of these subparts may have data that provides meaning to a name generated using this rule. Each of the subparts 812, 814, 816, 818, 820, 822, and 824, may include a subpart length. As an example, subpart 812 may has a subpart length of 3. As an example, subpart 814 may has a subpart length of 1. As an example, subpart 816 may has a subpart length of 3. As an example, subpart 818 may has a subpart length of 1. As an example, subpart 820 may has a subpart length of 2. As an example, subpart 822 may has a subpart length of 1. As an example, subpart 824 may has a subpart length of 5.

FIG. 8B illustrates an exemplary name 850 generated using a naming rule generated as a result of the network component naming and management process 100, according to embodiments. As shown in FIG. 8B, the shell 800 may be used to interpret the exemplary name 850. As an example, “uhn” formed from the first 3 characters of shell 800 may be used to determine that the virtual object and/or network device may be assigned a universal host name in the network. As another example, “tk2” may be used to identify the reference entity of the city of Tokyo and a second prefecture associated to Tokyo in the database. The numbers “01827” i.e., the last 5 characters may be used to determine a specific device with a range of possible devices.

FIG. 8C illustrates a diagram of a user interface 890 displaying a result generating a name for a virtual object and/or network device using the inputs indicated in user interface 700 of FIG. 7, according to embodiments.

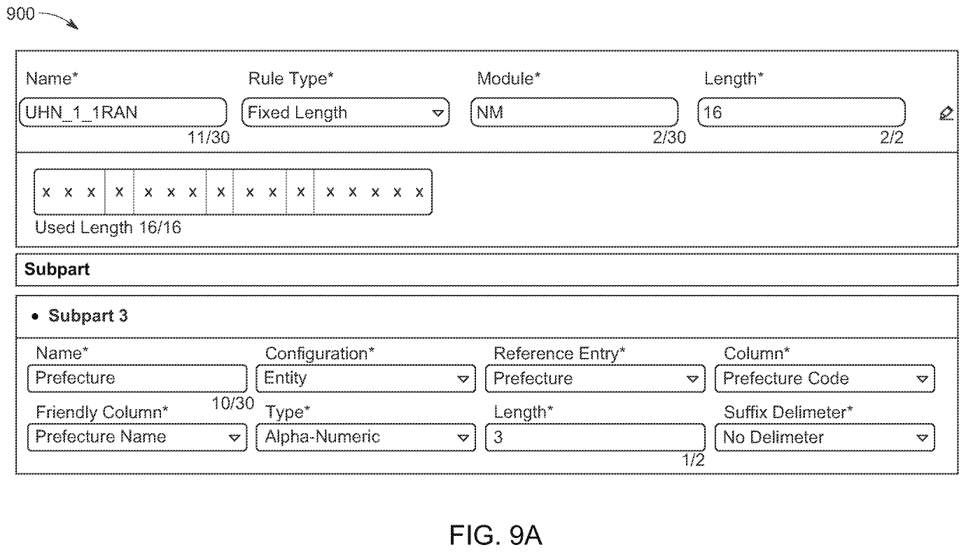

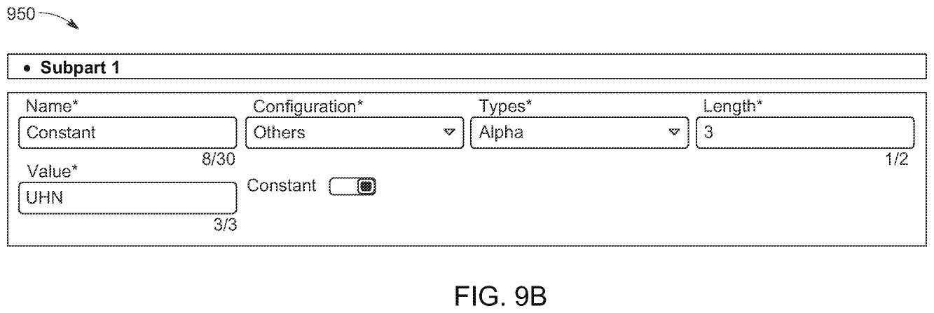

FIGS. 9A-B illustrate diagrams of a user interface 900 and 950 displaying a result of the network component naming and management process 100, according to embodiments. For example, FIG. 9A may illustrate defining and/or determining a naming rule including a subpart of entity configuration, with reference entity equal to prefecture, and a predetermined subpart length of 3. As shown in FIG. 9A, the naming rule has a first value of fixed length and a first length of 16. As another example, FIG. 9B may illustrate defining and/or determining a naming rule including a subpart of others configuration, with a constant configuration type of alphabets and subpart length of 3.

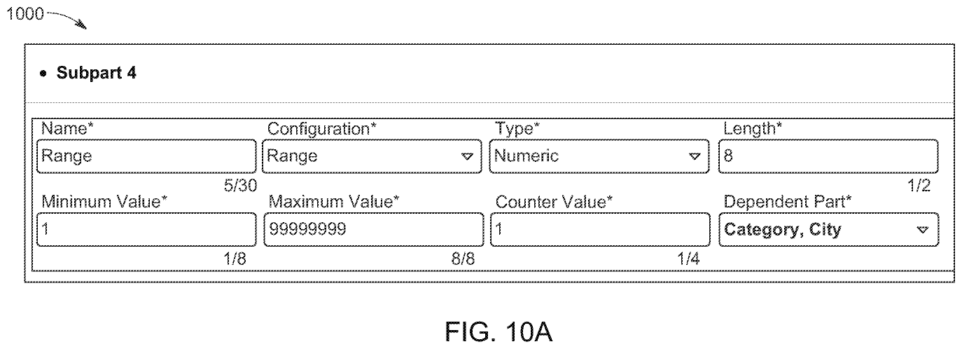

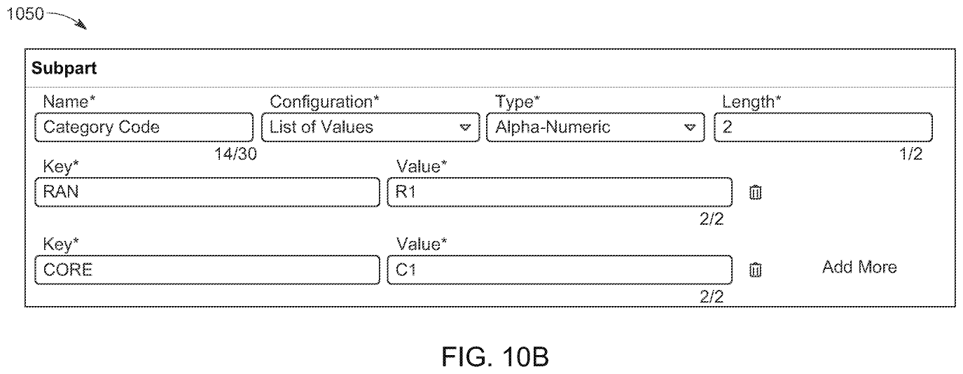

FIGS. 10A-B illustrate diagrams of a user interface 1000 and 1050 displaying a result of the network component naming and management process 100, according to embodiments. For example, FIG. 10A may illustrate defining and/or determining a naming rule including a subpart of range configuration, with a subpart length of 8, a minimum value of 1, a maximum value of 99999999, a counter value of 1, with the counter dependent on the reference entity city in another subpart. As another example, FIG. 10B may illustrate defining and/or determining a naming rule including a subpart of list of values configuration, with subpart length 2 and a one or more key-value pairs.

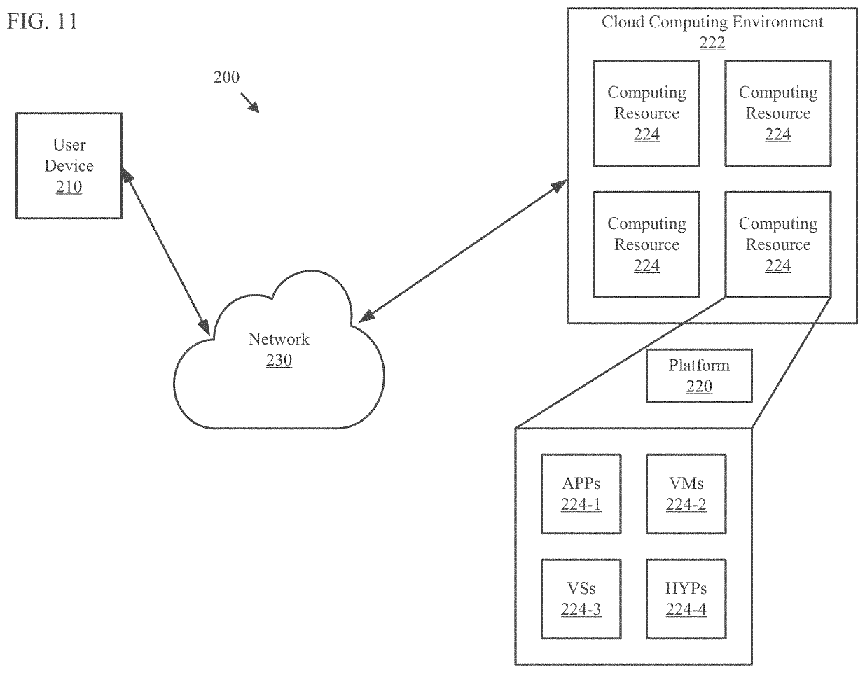

FIG. 11 is a diagram of an example environment 200 in which systems and/or methods, described herein, may be implemented. As shown in FIG. 11, environment 200 may include a user device 210, a platform 220, and a network 230. Devices of environment 200 may interconnect via wired connections, wireless connections, or a combination of wired and wireless connections. In embodiments, any of the functions of the elements included in network component naming and management system 100 may be performed by any combination of elements illustrated in FIG. 11. For example, in embodiments, user device 210 may perform one or more functions associated with name generation request 101 or naming admin 111, and platform 220 may perform one or more functions associated with any of name generation module 105, input validation 102, name generation 106, generated name repository 116, generated naming rule 112, rule subpart module 114, database 120, and naming rule definition module 115

User device 210 includes one or more devices capable of receiving, generating, storing, processing, and/or providing information associated with platform 220. For example, user device 210 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 210 may receive information from and/or transmit information to platform 220.

Platform 220 includes one or more devices capable of determining a heart rate of a subject using RPPG, as described elsewhere herein. In some implementations, platform 220 may include a cloud server or a group of cloud servers. In some implementations, platform 220 may be designed to be modular such that certain software components may be swapped in or out depending on a particular need. As such, platform 220 may be easily and/or quickly reconfigured for different uses.

In some implementations, as shown, platform 220 may be hosted in cloud computing environment 222. Notably, while implementations described herein describe platform 220 as being hosted in cloud computing environment 222, in some implementations, platform 220 is not be cloud-based (i.e., may be implemented outside of a cloud computing environment) or may be partially cloud-based.

Cloud computing environment 222 includes an environment that hosts platform 220. Cloud computing environment 222 may provide computation, software, data access, storage, etc. services that do not require end-user (e.g., user device 210) knowledge of a physical location and configuration of system(s) and/or device(s) that hosts platform 220. As shown, cloud computing environment 222 may include a group of computing resources 224 (referred to collectively as “computing resources 224” and individually as “computing resource 224”).

Computing resource 224 includes one or more personal computers, workstation computers, server devices, or other types of computation and/or communication devices. In some implementations, computing resource 224 may host platform 220. The cloud resources may include compute instances executing in computing resource 224, storage devices provided in computing resource 224, data transfer devices provided by computing resource 224, etc. In some implementations, computing resource 224 may communicate with other computing resources 224 via wired connections, wireless connections, or a combination of wired and wireless connections.

As further shown in FIG. 2, computing resource 224 includes a group of cloud resources, such as one or more applications (“APPs”) 224-1, one or more virtual machines (“VMs”) 224-2, virtualized storage (“VSs”) 224-3, one or more hypervisors (“HYPs”) 224-4, or the like.

Application 224-1 includes one or more software applications that may be provided to or accessed by user device 210. Application 224-1 may eliminate a need to install and execute the software applications on user device 210. For example, application 224-1 may include software associated with platform 220 and/or any other software capable of being provided via cloud computing environment 222. In some implementations, one application 224-1 may send/receive information to/from one or more other applications 224-1, via virtual machine 224-2.

Virtual machine 224-2 includes a software implementation of a machine (e.g., a computer) that executes programs like a physical machine. Virtual machine 224-2 may be either a system virtual machine or a process virtual machine, depending upon use and degree of correspondence to any real machine by virtual machine 224-2. A system virtual machine may provide a complete system platform that supports execution of a complete operating system (“OS”). A process virtual machine may execute a single program, and may support a single process. In some implementations, virtual machine 224-2 may execute on behalf of a user (e.g., user device 210), and may manage infrastructure of cloud computing environment 222, such as data management, synchronization, or long-duration data transfers.

Virtualized storage 224-3 includes one or more storage systems and/or one or more devices that use virtualization techniques within the storage systems or devices of computing resource 224. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 224-4 may provide hardware virtualization techniques that allow multiple operating systems (e.g., “guest operating systems”) to execute concurrently on a host computer, such as computing resource 224. Hypervisor 224-4 may present a virtual operating platform to the guest operating systems, and may manage the execution of the guest operating systems. Multiple instances of a variety of operating systems may share virtualized hardware resources.

Network 230 includes one or more wired and/or wireless networks. For example, network 230 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 11 are provided as an example. In practice, there may be additional devices and/or networks, fewer devices and/or networks, different devices and/or networks, or differently arranged devices and/or networks than those shown in FIG. 11. Furthermore, two or more devices shown in FIG. 11 may be implemented within a single device, or a single device shown in FIG. 11 may be implemented as multiple, distributed devices. Additionally, or alternatively, a set of devices (e.g., one or more devices) of environment 200 may perform one or more functions described as being performed by another set of devices of environment 200.

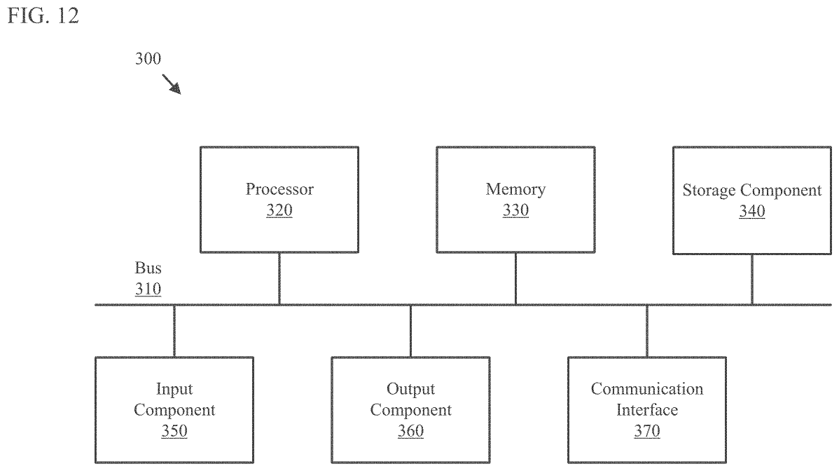

FIG. 12 is a diagram of example components of a device 300. Device 300 may correspond to user device 210 and/or platform 220. As shown in FIG. 12, device 300 may include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operation and use of device 300. For example, storage component 340 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 350 includes a component that permits device 300 to receive information, such as via user input (e.g., a touch screen display, a keyboard, a keypad, a mouse, a button, a switch, and/or a microphone). Additionally, or alternatively, input component 350 may include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 may permit device 300 to receive information from another device and/or provide information to another device. For example, communication interface 370 may include an Ethernet interface, an optical interface, a coaxial interface, an infrared interface, a radio frequency (RF) interface, a universal serial bus (USB) interface, a Wi-Fi interface, a cellular network interface, or the like.

Device 300 may perform one or more processes described herein. Device 300 may perform these processes in response to processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions may be read into memory 330 and/or storage component 340 from another computer-readable medium or from another device via communication interface 370. When executed, software instructions stored in memory 330 and/or storage component 340 may cause processor 320 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 12 are provided as an example. In practice, device 300 may include additional components, fewer components, different components, or differently arranged components than those shown in FIG. 12. Additionally, or alternatively, a set of components (e.g., one or more components) of device 300 may perform one or more functions described as being performed by another set of components of device 300.

In embodiments, any one of the modules or identification levels of FIG. 1 may be implemented by or using any one of the elements illustrated in FIGS. 11-12. For example any or one or more of name generation module 105, input validation 102, name generation 106, generated name repository 116, generated naming rule 112, rule subpart module 114, database 120, name generation request 101, naming admin 111, and naming rule definition module 115 may be implemented by or correspond to any one or more of user device 210, platform 220, computing resource 224, or one or more components of device 300.

Although FIGS. 2-6 shows example blocks of process 200, 300, 400, 500, and 600, in some implementations, processes 200, 300, 400, 500, and 600 may include additional blocks, fewer blocks, different blocks, or differently arranged blocks than those depicted in FIGS. 2-6. In embodiments, one or more blocks of example blocks of process 200, 300, 400, 500, and 600 may be combined or arranged in any order or amount. In embodiments, two or more of the blocks of processes 200, 300, 400, 500, and 600 may be performed in parallel.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Furthermore, as used herein, the term “set” is intended to include one or more items (e.g., related items, unrelated items, a combination of related and unrelated items, etc.), and may be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A method of naming network components, the method being performed by at least one processor and comprising:
determining a first value associated with a naming rule, the first value indicating a type of naming rule;
determining a first length associated with the naming rule, wherein the first length is based on the first value;
determining at least one or more subparts associated with the naming rule, wherein each of the at least one or more subparts comprises a configuration and a subpart length, and wherein a combined subpart length of each of the at least one or more subparts is equal to the first length; and
generating the naming rule for naming network components rule based on the first value, the first length, and the at least one or more subparts.

2. The method of claim 1, further comprising assigning an identifier to at least one virtual object using the naming rule.

3. The method of claim 1, wherein the naming rule comprises a first naming rule, and the method further comprises:
generating a second naming rule based on a second value, a second length, and one or more second subparts; and
assigning an identifier to at least one virtual object using a combination of the first naming rule and the second naming rule.

4. The method of claim 1, wherein the determining of the at least one or more subparts associated with the naming rule comprises identifying a reference entity from a predefined list of one or more reference entities based on determining that the configuration matches a pre-defined configuration.

5. The method of claim 4, wherein the predefined list of one or more reference values is extracted from one of an internal or external database.

6. The method of claim 1, wherein the determining of the at least one or more subparts associated with the naming rule comprises identifying at least one key-value pair based on determining that the configuration matches a pre-defined configuration.

7. The method of claim 1, further comprising assigning an identifier indicating a dependency to at least one virtual object using the naming rule based on determining that a first subpart of the one or more subparts may depend on a second subpart of the one or more subparts.

8. The method of claim 1, wherein the first value and the first length are obtained from a user through one of a user interface or an application programming interface.

9. The method of claim 2, further comprising revocation of the assigned identifier based on receiving user input indicating revocation.

10. A device for naming network components, the device comprising:
a memory configured to store instructions; and
one or more processors configured to execute the instructions to:
determine a first value associated with a naming rule, the first value indicating a type of naming rule;
determine a first length associated with the naming rule, wherein the first length is based on the first value;
determine at least one or more subparts associated with the naming rule, wherein each of the at least one or more subparts comprises a configuration and a subpart length, and wherein a combined subpart length of each of the at least one or more subparts is equal to the first length; and
generate the naming rule for naming network components based on the first value, the first length, and the at least one or more subparts.

11. The device of claim 10, wherein the one or more processors are further configured to execute the instructions to assign an identifier to at least one virtual object using the naming rule.

12. The device of claim 10, wherein the naming rule comprises a first naming rule, and the one or more processors are further configured to:
generate a second naming rule based on a second value, a second length, and one or more second subparts; and
assign an identifier to at least one virtual object using a combination of the first naming rule and the second naming rule.

13. The device of claim 10, wherein the determining of the at least one or more subparts associated with the naming rule comprises identifying a reference entity from a predefined list of one or more reference entities based on determining that the configuration matches a pre-defined configuration.

14. The device of claim 10, wherein the determining of the at least one or more subparts associated with the naming rule comprises identifying at least one key-value pair based on determining that the configuration matches a pre-defined configuration.

15. The device of claim 10, the one or more processors are further configured to assign an identifier indicating a dependency to at least one virtual object using the naming rule based on determining that a first subpart of the one or more subparts may depend on a second subpart of the one or more subparts.

16. The device of claim 11, wherein the one or more processors are further configured to execute the instructions to revoke the assigned identifier based on receiving user input indicating revocation.

17. A non-transitory computer-readable medium storing instructions, the instructions comprising: one or more instructions that, when executed by one or more processors of a device for automatic troubleshooting, cause the one or more processors to:
determine a first value associated with a naming rule, the first value indicating a type of naming rule;
determine a first length associated with the naming rule, wherein the first length is based on the first value;
determine at least one or more subparts associated with the naming rule, wherein each of the at least one or more subparts comprises a configuration and a subpart length, and wherein a combined subpart length of each of the at least one or more subparts is equal to the first length; and
generate the naming rule for naming network components based on the first value, the first length, and the at least one or more subparts.

18. The non-transitory computer-readable medium of claim 17, comprising instructions that further cause the one or more processors to assign an identifier to at least one virtual object using the naming rule.

19. The non-transitory computer-readable medium of claim 17, wherein the naming rule comprises a first naming rule, and comprising instructions that further cause the one or more processors to:
generate a second naming rule based on a second value, a second length, and one or more second subparts; and
assign an identifier to at least one virtual object using a combination of the first naming rule and the second naming rule.

20. The non-transitory computer-readable medium of claim 17, comprising instructions that further cause the one or more processors to assign an identifier indicating a dependency to at least one virtual object using the naming rule based on determining that a first subpart of the one or more subparts may depend on a second subpart of the one or more subparts.
